(19) United States
(12) Patent Application Publication
(10) Pub. No.: US 2004/0265426 A1
(43) Pub. Date: Dec. 30, 2004

(54) Process for producing miso

(75) Inventors: Yasushi Sakai, Tsukuba-shi (JP); Ayako Muromachi, Tsukuba-shi (JP); Miho Takada, Tsukuba-shi (JP); Mika Hashimoto, Tsukuba-shi (JP); Takahiro Hara, Tokyo (JP); Noriyoshi Ichijo, Nagano-shi (JP); Takehiro Nishida, Nagano-shi (JP)

Correspondence Address: VENABLE, BAETJER, HOWARD AND CIVILETTI, LLP, P.O. BOX 34385, WASHINGTON, DC, 20043-9998, US

(73) Assignees: KYOWA HAKKO KOGYO CO., LTD., Tokyo (JP); MARUKOME CO., LTD, Nagano (JP)

(21) Appl. No.: 10/866,062

(22) Filed: Jun. 14, 2004

(30) Foreign Application Priority Data
Jun. 13, 2003 (JP) 2003-169793

(51) Int. Cl. A23K 1/00

(52) U.S. Cl. 426/49

(57) ABSTRACT

According to the process, miso where a lipid metabolism improving action, particularly, a cholesterol lowering action, is potentiated is obtained. There is provided a process for producing miso comprising subjecting a prepared mixture of materials for miso to aging followed by a heating treatment preferably at 70 to 95° C. (substance temperature) for 3 to 40 minutes and then adding thereto phospholipid so as to make its content based on 100 parts by weight of the resulting dried miso 0.4 to 2.0 part(s) by weight.

### CROSS-REFERENCE TO RELATED APPLICATION

This application claims the priority of Japanese Patent Application No. 2003-169793, filed on Jun. 13, 2003, the subject matter of which is incorporated herein by reference.

### BACKGROUND OF THE INVENTION

The present invention relates to a process for producing miso (soybean paste), as well as a method of potentiating a lipid metabolism improving action of miso, etc.

Lipid metabolism is a process where lipid mainly comprising triglycerides derived from food is catabolized (decomposed) and anabolized (accumulated) in vivo and, in a broad sense, it covers reactions for transforming lipids into energy, biosynthesis of fatty acids, biosynthesis of acylglycerols, metabolism of phospholipid, metabolism of cholesterol, etc (Biochemistry for Nutrition Science, Asakura Shoten, 1993, pages 123 to 125). In recent years, mortality from adult diseases, particularly from diseases of cardiovascular system, is increasing and the correlation between ratio of risk of onset thereof and lipid concentration in blood has been pointed out. Under such circumstances, there has been an attempt for lowering the lipid concentration in blood, particularly the cholesterol concentration therein, by use of components in food.

Miso (soybean paste) is indispensable in the meals for Japanese and is a food which is taken on a daily basis. Miso has been known to have an action of lowering the cholesterol in blood [Chuo Miso Kenkyusho Hokoku (Report of Central MISO Research Institute), 1988, No. 16, pages 53 to 57]. Accordingly, it is useful from the viewpoint of prevention and treatment of adult diseases to potentiate the action of miso for lowering the cholesterol in blood.

Phospholipid has been known as a substance for lowering the cholesterol concentration in blood and it has been confirmed by animal experiments that, for example, when soybean phospholipid is added to the feed in an amount of as much as not less than several %, there is achieved a physiological effect such as an effect of lowering the cholesterol concentration in blood [Nippon Eiyo Shokuryo Gakkaishi (Journal of Japanese Society of Nutrition and Food Science), 1988, Volume 41, pages 23 to 28].

With regard to methods of lowering the cholesterol concentration in blood, there have been known a method where textured soybean protein containing soybean lecithin is used (Annu. Nutr. Metab., 1985, Volume 29, pages 348 to 357) and a method where protein/phospholipid complex or protein hydrolyzate/phospholipid complex is used(hereinafter, abbreviated as CSPHP) (WO 09059/97). It has been also known that, when CSPHP is added to miso, cholesterol concentration in blood is able to be lowered (Japanese Pharmacology & Therapeutics, 2003, Volume 31, No. 2, pages 155 to 161).

As an example of adding phospholipid to miso, mention may be made of a process for producing instant miso soup, in which starch, garnish, seasoning, etc. in addition to miso prepared by a conventional process are mixed and dissolved in milk or water and then sodium acidic citrate and egg yolk lecithin are added to the solution for stabilization before or after freeze-drying whereupon an instant miso soup is produced (Japanese Published Unexamined Patent Application No. 134978/83) and, in this producing process, egg yolk lecithin is useful in enhancing nutritional value and has an effect of dispersing and stabilizing the material components. As to a process for producing solid miso, there has been also known a process where miso which is prepared by a conventional process is dried and lecithin or the like is added thereto as an emulsifier to solidify whereupon solid miso is prepared (Japanese Published Examined Patent Application No.43920/77). There has been further known a process for producing miso where, in any of the steps for producing miso, a predetermined amount of steamed and mashed root crops of rhizomes is mixed followed by mixing health foods therewith (Japanese Published Unexamined Patent Application No. 236447/95). In the reference, lecithin is mentioned among many health foods listed therein. Furthermore, there have been known a process for producing miso where a predetermined amount of docosahexaenoic acid, (spicy plant component) and a predetermined amount of lecithin are added to miso (Japanese Published Unexamined Patent Application Nos. 276989/94 and 237729/94).

On the other hand, it has been known that phospholipid is decomposed during producing miso. For example, although lecithin is contained in soybean which is a material for miso, it is decomposed and, therefore, concentration of lecithin in miso is usually not more than 0.2% in terms of a dry weight ratio. With regard to suppression of decomposition of phospholipid, it has been reported that, when a koji extract is heated at 100° C. for 5 minutes followed by adding soybean lecithin thereto, decomposition of soybean lecithin is suppressed (Nippon Shokuhin Kogyo Gakkaishi, 1969, Volume 16, No. 2, pages 57 to 62).

As mentioned hereinabove, miso used for miso soup which is taken by Japanese on a daily basis has been known to have an action of lowering the cholesterol and there has been a demand for providing miso having an excellent lipid metabolism improving action such as a cholesterol lowering action together with keeping the good taste of miso. As mentioned above, it has been also known that CSPHP is added to miso but there is a necessity of supplemental step for making protein/phospholipid complex. It has been further known that phospholipid such as lecithin is used for producing miso products for improvement of nutrition and as an emulsifier. As such, although it has been known that miso has an action of lowering the cholesterol and that phospholipid is added to miso, it has not been known at all to add phospholipid to miso from a viewpoint of potentiation of a lipid metabolism improving action of miso. A problem of the present invention is to provide a method of potentiating a lipid metabolism improving action, particularly a cholesterol lowering action, of miso and also to provide a process for producing miso having such an improved action.

### SUMMARY OF THE INVENTION

The present invention relates to a method of potentiating a lipid metabolism improving action of miso, which comprises subjecting a prepared mixture of materials for miso to aging followed by a heating treatment, and then adding thereto phospholipid (the first aspect); the method of potentiating a lipid metabolism improving action of miso according to the first aspect, wherein the heating treatment is conducted for 3 to 40 minutes where the substance temperature is 70° C. to 95° C. (the second aspect); the method of potentiating a lipid metabolism improving action of miso according to the first aspect, wherein the heating treatment is conducted for 3 to 5 minutes where the substance temperature is 75° C. to 85° C. (the third aspect); the method of potentiating a lipid metabolism improving action of miso according to any of the first to third aspects, wherein further aging is carried out after addition of the phospholipid (the fourth aspect); the method of potentiating a lipid metabolism improving action of miso according to any of the first to fourth aspects, wherein the phospholipid is added so as to make its content based on 100 parts by weight of dried product of the miso 0.4 to 2.0 part(s) by weight (the fifth aspect); the method of potentiating a lipid metabolism improving action of miso according to any of the first to fifth aspects, wherein the phospholipid is an enzyme-modified lecithin (the sixth aspect); and the method of potentiating a lipid metabolism improving action of miso according to any of the first to sixth aspects, wherein the lipid metabolism improving action is a cholesterol lowering action (the seventh aspect).

The present invention also relates to a process for producing miso, which comprises subjecting a prepared mixture of materials for miso to aging followed by a heating treatment, and then adding thereto phospholipid (the eighth aspect); the process for producing miso according to the eighth aspect, wherein the heating treatment is conducted for 3 to 40 minutes where the substance temperature is 70° C. to 95° C. (the ninth aspect); the process for producing miso according to the eighth aspect, wherein the heating treatment is conducted for 3 to 5 minutes where the substance temperature is 75° C. to 85° C. (the tenth aspect); the process for producing miso according to any of the eighth to tenth aspects, wherein further aging is carried out after addition of the phospholipid (the eleventh aspect); the process for producing miso according to any of the eighth to eleventh aspects, wherein the phospholipid is added so as to make its content based on 100 parts by weight of dried product of the miso 0.4 to 2.0 part(s) by weight (the twelfth aspect); the process for producing miso according to any of the eighth to twelfth aspects, wherein the phospholipid is an enzyme-modified lecithin (the thirteenth aspect); and the process for producing miso according to any of the eighth to thirteenth aspects, wherein the lipid metabolism improving action is a cholesterol lowering action (the fourteenth aspect).

The present invention further relates to miso obtainable by the process according to any of the eighth to fourteenth aspects (the fifteenth aspect); to a food or drink containing the miso mentioned in the fifteenth aspect (the sixteenth aspect); to a method of treating or preventing diseases selected from the group consisting of fatty liver, hypertension, hyperlipemia, arteriosclerosis, obesity, diabetes and myocardial infarction in human or non-human, which comprises ingesting miso according to the fifteenth aspect(seventeenth aspect); to a method of treating or preventing diseases selected from the group consisting of fatty liver, hypertension, hyperlipemia, arteriosclerosis, obesity, diabetes and myocardial infarction in human or non-human, which comprises ingesting the food or drink according to the sixteenth aspect (the eighteenth aspect); and to a method of improving lipid metabolism in human or non-human, which comprises administrating a pharmaceutical preparation comprising miso according to the fifteenth(the nineteenth aspect).

### BRIEF DESCRIPTION OF THE DRAWING

FIG. 1 is a drawing which shows the relation between the content of phospholipid in miso and taste of miso. An abscissa shows the content (parts by weight) of phospholipid based on 100 parts by weight of dried product of miso and an ordinate shows the evaluation point of each miso product as a result of an organoleptic test for the taste of the miso.

### DETAILED DESCRIPTION OF THE INVENTION

The phospholipid used in the present invention includes phosphatidylcholine, phosphatidylethanolamine, phosphatidylinositol, phosphatidylserine, sphingomyelin and phosphatidic acid, lecithin which is a mixture of these compounds and the like.

With regard to the lecithin, that derived from animals such as brain, liver and egg yolk, that derived from plants such as soybean and that derived from microorganisms such as yeast may be exemplified and, among them, lecithin derived from soybean and egg yolk may be appropriately exemplified. Although lecithin may be used as it is, an enzyme-modified lecithin which is prepared by the treatment of lecithin with an enzyme such as phospholipase is preferred. With regard to the enzyme-modified lecithin, that which is selected from lecithin treated with phospholipase A, lecithin treated with phospholipase D and lecithin treated with phospholipases A and D or a combination of two or more members thereof may be used. Such a phospholipid used in the present invention has been put into the market and is easily available. For example, as a commercially available enzyme-modified lecithin, Elmizer AC (manufactured by T&K Lecithin) may be exemplified.

For producing miso which is applied in the method of potentiating a lipid metabolism improving action of miso according to the present invention and in the process for producing miso according to the present invention, a conventional process for producing miso is used except the presence of a heating step and a step for addition of phospholipid. For example, a process for producing miso having the following steps (a) to (d) is mentioned.

(a) a step where soybean is washed, soaked, steamed or boiled and cooled;

(b) a step where rice, barley, soybean or the like is washed, soaked, steamed or boiled and cooled and further subjected to being malted into koji;

(c) a step where salt, water and, if necessary, yeast, lactic acid bacteria, etc. are mixed with the steamed or boiled soybean prepared in the above (a) and the koji prepared in the above(b) and then the mixture is stirred so as to make it uniform; and

(d) a step where the mixture obtained in the above (c) is charged in a container and aged.

In the present invention, a mixture in which materials for miso such as soybean, koji and salt are mixed is called a prepared mixture of materials for miso. In the above example for the producing process of miso, the mixture obtained in the step (c) is a prepared mixture of materials for miso. Further, in the present invention, miso is a product obtained by aging of the prepared mixture of material for miso. Accordingly, in a method of potentiating a lipid metabolism improving action of miso according to the present invention, it is necessary that the miso after aging is subjected to a heating treatment and that, after the heating treatment, phospholipid is added thereto. It is preferred to conduct a further aging after addition of phospholipid for causing the affection by the added phospholipid to be mild.

It is preferred that the heating treatment is carried out after taking out the miso from the preparation container after completion of the aging. With regard to the method for heating, any method may be used so far as the miso can be heated and its examples are direct or indirect heating methods such as a heating method by means of irradiation of microwave, a heating method by infrared ray or far-infrared ray, a heating method by Joule heat such as application of electricity and a heating method by steam or the like and, among them, a preferred one is a method by which a uniform heating is possible such as a heating by application of electricity and an indirect heating with stirring.

With regard to the condition for the heating treatment, there is no particular limitation so far as it is a treating condition by which a lipid metabolism improving action of miso by phospholipid added thereto after the heating treatment is able to be potentiated, and a heating treatment condition having no affection to the taste of miso, miso soup, etc. is preferred. It is preferred that the condition for the heating treatment is stipulated by heating temperature and heating time and, with regard to the heating temperature, it is more appropriate to express in terms of the substance temperature. For example, it is preferred to heat at a substance temperature of 70 to 95° C. for 3 to 40 minutes or, to be more specific, at a substance temperature of 70° C. for 10 to 40 minutes, preferably for 10 minutes, at a substance temperature of 75° C. for 5 to 30 minutes, preferably for 5 minutes, at a substance temperature of 85° C. for 3 to 20 minutes, preferably for 3 minutes, or at a substance temperature of 95° C. for 3 to 10 minutes, preferably for 3 minutes. Among them, heating at a substance temperature of 75 to 85° C. for 3 to 5 minutes is particularly preferred. In the case of heating at a substance temperature below 70° C., residual amount of phospholipid becomes the lower. When the substance temperature is higher than 95° C., aroma of miso is deteriorated and there is a risk of turning brown color. Table 1 shows heating treatment condition for miso and residual rate of phospholipid in miso.

TABLE 1

| Heating Temperature | Time for Heating | Residual Rate of |
|---|---|---|
| (Substance Temperature) | Treatment | Phospholipid (%) |
| 90° C. | 10 minutes | 100 |
| 85° C. | 5 minutes | 99 |
| | 3 minutes | 99 |
| 75° C. | 10 minutes | 100 |
| | 5 minutes | 100 |
| | 3 minutes | 43 |
| 65° C. | 10 minutes | 54 |
| | 5 minutes | 34 |
| | 3 minutes | 14 |

In a method of poentiating a lipid metabolism improving action of miso according to the present invention and in a process for produces miso according to the present invention, there is no particular limitation for the amount of phospholipid such as an enzyme-modified lecithin to be added to miso after the heating treatment so far as it is an amount which is able to potentiate the lipid metabolism improving action of miso although it is preferred to add so as to make not less than 0.2 part by weight or, preferably, from not less than 0.4 part by weight to not more than 2.0 parts by weight based on 100 parts by weight of dried product of miso. When phospholipid is added to miso after the heating treatment, it is possible to potentiate a lipid metabolism improving action of miso or, in other words, to potentiate the action inherent to miso for lowering the total cholesterol concentration in blood, LDL cholesterol concentration in blood and concentration of neutral fat as compared with the use of miso which is prepared without a heating treatment and without addition of phospholipid, prepared without a heating treatment and with addition of phospholipid and prepared by a heating treatment without addition of phospholipid. When phospholipid is added to make the content less than 0.2 part by weight, there are some cases where the phospholipid content is unchanged as compared with that of miso to which no phospholipid is added and, in such a case, there is no significant difference in a lipid metabolism improving action. In view of the taste, it is preferred to add phospholipid so as to make the content not more than 2.0% by weight. It is also possible to conduct further aging after addition of phospholipid to miso which was subjected to a heating treatment. An aging period after addition of phospholipid is preferably 1 day to 1 year, more preferably from 1 day to six months and, still more preferably, from 1 to 10 day(s). After addition of phospholipid, regardless of the aging, it is possible to prepare a dried product of miso in such a manner that the resulting miso is dried by means of drying with hot air, freeze-drying, etc.

With regard to a method of quantifying phospholipid in miso, a common method of quantifying phospholipid amount in a food or drink may be used although it is preferred to quantify according to “Standard Test Method for Analysis of Fat/Oil” edited by the Japan Oil Chemists' Society. Commercially available kits such as Phospholipid Test Wako manufactured by Wako Pure Chemicals may be used as well.

Phospholipid may be added as it is, and it may also be added together, if necessary, with an additive which is usable for a food or drink such as inorganic salt, acid, protein, protein/phospholipid complex or protein hydrolyzate/phospholipid complex (CSPHP manufactured, for example, by Kyowa Hakko), amino acid, nucleic acid and saccharide. Examples of the above inorganic salt include sodium chloride, potassium chloride and ammonium chloride. Examples of the above acid include ascorbic acid, fumaric acid, malic acid, tartaric acid, citric acid, carboxylic acid such as fatty acid and salt thereof and examples of the salt include sodium salt and potassium salt. Examples of the above protein include plant protein such as soybean protein and wheat protein, and animal protein such as milk protein, domestic animal meat protein, fish meat protein and egg white protein. Examples of the above amino acid include sodium glutamate and glycine. Examples of the above nucleic acid include sodium inosinate and sodium guanylate. Examples of the above saccharide include sucrose, glucose and lactose.

Phospholipid and other additives which are added upon necessity may be added to miso as they are or may be added after suspending in a medium such as water. With regard to a method of addition, any method may be used so far as it is a method by which a uniform mixing is conducted into miso, if necessary, with stirring.

As mentioned above, with regard to the miso of the present invention, there is no particular limitation so far as it is a miso which is produced by the above-mentioned process for producing miso. With regard to the miso of the present invention, it may be used as it is as a miso or, if necessary, it may be used after addition of above-mentioned various additives which are usable together with phospholipid as well as spice, seasoning, etc. With regard to the spice, various kinds of spices may be exemplified and, with regard to the seasoning, natural seasonings such as soy sauce and extract may be exemplified.

With regard to the food or drink of the present invention, there is no particular limitation so far as it contains the miso of the present invention. Examples of the food or drink used include soup, stew, juice, refreshing drink, tea, lactic acid bacteria beverage, ice cream, milk, milk products (butter, cheese, yogurt, processed milk, defatted milk, etc.), meat of domestic animals, products of domestic animal meat (ham, sausage, hamburger, etc.), fish meat, fish meat products [kamaboko (boiled fish paste), chikuwa (a kind of Japanese fish paste), satsumaage (deep-fried cake of ground fish), sausage, etc.], egg, egg products [dashimaki (soy-flavored and rolled omelet), tamagodofu (steamed egg custard), etc.], confectionery (cookie, jelly, snack, etc.), bread, noodle, pickles, smoked product, dried fish, tsukudani (food boiled down in soy) and salted product and they may be produced by the conventional process for producing a food or drink except addition of miso. Examples of the form of the food or drink as such include natural liquid diet, semi-digested diet, and elemental diet.

When the above-mentioned miso of the present invention or the food or drink containing the miso of the present invention is ingested, lipid metabolism in human or non-human can be improved. Particularly, metabolism of cholesterol is improved so that cholesterol concentration in blood can be lowered. Accordingly, the miso of the present invention or the food or drink containing the miso of the present invention is able to be appropriately used for preventing or treating diseases in human or non-human such as fatty liver, hypertension, hyperlipemia, arteriosclerosis, obesity, diabetes and myocardial infarction. There is no particular limitation for the ingesting amount of the miso of the present invention or the food or drink containing the miso of the present invention and, in addition, the ingesting amount varies depending upon ingestion form, degree of symptom, age, body weight, etc. although, in order to achieve a lowering action for cholesterol concentration in blood, it is preferred to ingest 1 to 50 g per day, more preferably, 5 to 30 g per day for adult as a dried product of the miso of the present invention. Although there is no particular limitation for the ingestion period, it is usually from one day to one year, preferably, from one week to three months.

With regard to the lipid metabolism improving agent of the present invention, there is no particular limitation so far as the miso of the present invention is an effective ingredient and the miso to which one or more pharmaceutically acceptable carriers are mixed if necessary is made into a pharmaceutical agent by any of methods which have been well known in the technical field of pharmaceutical sciences whereupon a lipid metabolism improving agent is able to be prepared. Examples of the administration route of the lipid metabolism improving agent of the present invention include oral and parenteral routes, and an oral route is preferred. Examples of the dosage form to be administered include tablets, triturations, granules, pills, capsules, suspensions, emulsions, elixirs, syrups, liquids, infusions, decoctions, extracts, tinctures and fluid extracts. In producing of oral agents, additives such as excipients, binders, disintegrators, lubricants, dispersing agents, suspending agents, emulsifying agents, diluents, buffers, antioxidants and bacteria suppressants may be used.

When dosage form of an oral agent is tablet, trituration, granule, etc., the agent can be produced by addition of excipient including saccharide such as lactose, sugar, glucose, sucrose, mannitol and sorbitol, starch such as that of potato, wheat and corn, inorganic substance such as calcium carbonate, calcium sulfate, sodium hydrogen carbonate and sodium chloride, crystalline cellulose, plant powder such as licorice powder and gentian powder; disintegrators including starch, agar, gelatin powder, crystalline cellulose, carmellose sodium, carmellose calcium, calcium carbonate, sodium hydrogen carbonate and sodium alginate; lubricant including magnesium stearate, talc, hydrogenated plant oil, Macrogol and silicone oil; binder including polyvinyl alcohol, hydroxypropyl cellulose, methyl cellulose, ethyl cellulose, carmellose, gelatin and starch paste; surfactants including fatty acid ester; plasticizer including glycerol; etc. When the dosage form of an oral agent is a liquid one such as syrup, it is possible to produce an agent by addition of water, saccharide such as sucrose, sorbitol and fructose, glycol such as polyethylene glycol and propylene glycol, oil such as sesame oil, olive oil and soybean oil, antiseptic such as p-hydroxybenzoate, flavor such as strawberry flavor and peppermint, etc.

Although the amount of the miso of the present invention in the lipid metabolism improving agent of the present invention is not particularly limited, it is preferred to be 1 to 100 part(s) by weight or, more preferably, 10 to 100 parts by weight based on 100 parts by weight of the lipid metabolism improving agent of the present invention. There is no particular limitation for the administration amount of the lipid metabolism improving agent of the present invention and the administration amount varies depending upon ingestion form, degree of symptom, age, body weight, etc. although, in order to achieve a lowering action for cholesterol concentration in blood, it is preferred to ingest 1 to 50 g, more preferably, 5 to 30 g per day for adult as a dry product of the miso of the present invention.

Test Example is shown below.

### TEST EXAMPLE 1

Male rats of Wistar strain of five weeks age were used, subjected to a preliminary breeding by giving a commercially available solid feed (CE-2; manufactured by Nippon Claire) for three days and divided into groups where each group comprised six rats so as not to result in significant difference in body weight. After the preliminary acclimation, they were fasted for 18 hours and allowed to freely ingest the feed 1 to 4 having the compositions as shown in Table 2 and water for nine days and such groups were called test groups 1 to 4. Values in Table 2 are parts by weight.

Amount of an enzyme-modified lecithin contained in 100 parts of the feed was 0 part by weight, 0.4 part by weight, 0.04 part by weight and 0.32 part by weight in the feed 1, 2, 3 and 4, respectively.

TABLE 2

| | | | | Feed |
|---|---|---|---|---|
| | Feed 1 | Feed 2 | Feed 3 | 4 |
| Casein | 200 | 200 | 200 | 200 |
| Minerals * AIN 76 | 35 | 35 | 35 | 35 |
| (manufactured by Oriental Yeast) | | | | |
| Vitamins * AIN 76 | 10 | 10 | 10 | 10 |
| (manufactured by Oriental Yeast) | | | | |
| Choline chloride | 2 | 2 | 2 | 2 |
| Cholesterol | 5 | 5 | 5 | 5 |
| Sodium cholate | 2.5 | 2.5 | 2.5 | 2.5 |
| Enzyme-modified lecithin | — | 4 | — | — |
| Dry product A obtained in Example 1 | — | — | — | 200 |
| Dry product B obtained in Example 1 | — | — | 200 | — |
| Lard | 50 | 50 | 50 | 50 |
| Corn oil | 10 | 10 | 10 | 10 |
| Sucrose | 200 | 200 | 200 | 200 |
| Cellulose | 50 | 50 | 50 | 50 |
| Starch | 435.5 | 435.5 | 435.5 | 435.5 |

After breeding for nine days, the rats were fasted for 18 hours and blood was collected from abdominal aorta under anesthetization with sodium pentobarbital (manufactured by Wako Pure Chemical). The blood was centrifuged (at 4° C. and 3,000 rpm for 10 minutes) to collect serum. Total cholesterol concentration, LDL cholesterol concentration and neutral fat concentration in the serum were determined using a determiner TC 555 (manufactured by Kyowa Medex), a determiner L LDL-C (manufactured by Kyowa Medex) and a triglyceride G test Wako (manufactured by Wako Pure Chemical), respectively which were commercially available measuring kits according to the instructions attached thereto. Average body weight for each group before addition of the feed was 102 g while average body weight for each group after 10 days was 154 to 159 g and there was no significant difference among the groups. Total cholesterol concentration, LDL cholesterol concentration and neutral fat concentration in the serum of each group are shown in Table 3. The experimental results are shown in terms of mean value±standard error.

TABLE 3

| | Total | LDL | |
|---|---|---|---|
| Test | Cholesterol | Cholesterol | Neutral Fat |
| Groups | (mg/dl) | (mg/dl) | (mg/dl) |
| 1 | 293 ± 11 | 230 ± 21 | 64 ± 10 |
| 2 | 309 ± 14 | 249 ± 15 | 64 ± 8 |
| 3 | 199 ± 14 | 144 ± 15 | 49 ± 10 |
| 4 | 177 ± 20 | 109 ± 14 | 40 ± 5 |

As shown in Table 3, total cholesterol concentrations in blood in the test group 2 to which a feed containing only an enzyme-modified lecithin was given was almost the same as that in the test group 1 (control group) to which the feed 1 was given. In the test group 3 to which a feed where dried product (dry product B) of miso containing no enzyme-modified lecithin without heating treatment was added was given, the concentration apparently lowered as compared with the test group 1 and the test group 2. In the test group 4 to which a feed where dried product (dry product A) of miso prepared by addition of enzyme-modified lecithin after the heating treatment was added was given, total cholesterol concentration in blood apparently lowered as compared with the test group 1, the test group 2 and the test group 3. Incidentally, phospholipid concentration in the feed is lower in the feed (feed 4) used for the test group 4 than the feed (feed 2) used for the test group 2. From the above, it is apparent that an action of miso for lowering cholesterol in blood is able to be potentiated in cases where an enzyme-modified lecithin in such an amount that an effect of lowering cholesterol concentration in blood is not noted, when it is ingested solely in that amount, is added to miso which is subjected to a heating treatment. Incidentally, in any of LDL cholesterol concentration and neutral fat concentration, the same tendency as in the total cholesterol concentration in blood was noted.

The present invention is now more specifically illustrated as hereunder by way of Examples although the technical scope of the present invention is not limited to those Examples.

### EXAMPLE 1

(a) Soybean (34 kg), 17 kg of rice, 12 kg of salt and 37 kg of water were used as materials and subjected to preparation, mixing and aging according to conventional methods to give 100 kg of miso. The miso was heated at 85° C. (substance temperature) for 5 minutes by means of an indirect steam heating with stirring using a static mixer (manufactured by Noritake). Elmizer AC (an enzyme-modified lecithin manufactured by T&K Lecithin) (1.0 kg) was added thereto and the mixture was mixed for 10 minutes using a kneader and aged for 1 week more to give miso A. The miso A (1 kg) was freeze-dried to give about 500 g of a dried product of miso. The dried product of miso was named a dry product A.

(b) Miso B was produced according to the same process for producing miso A in (a) except that heating at 85° C. for 5 minutes was not conducted and Elmizer AC was not added. The miso B (1 kg) was freeze-dried to give about 500 g of a dried product of miso. The dried product of miso was named a dry product B.

(c) Miso C was produced according to the same process for producing miso A in (a) except that Elmizer AC was not added. The miso C (1 kg) was freeze-dried to give about 500 g of a dried product of miso. The dried product of miso was named a dry product C.

(d) Miso D was produced according to the same process for producing miso A in (a) except that heating at 85° C. for 5 minutes was not conducted. The miso D (1 kg) was freeze-dried to give about 500 g of a dried product of miso. The dried product of miso was named a dry product D.

Each 1 g of the above dry products A to D was placed in a 50-ml glass flask, 20 g of chloroform containing 5% (v/v) methanol were added and the mixture was kept at about 40° C. for 30 minutes. After a centrifugal separation, the extract was transferred to a 300-ml eggplant type flask by means of decantation. To the residue after extraction remained in the glass flask was added 20 g of chloroform containing 5% (v/v) methanol and the mixture was kept at about 40° C. for 30 minutes. The extract was transferred to an eggplant type flask and mixed with the already-prepared extract. To the extract residue remained in the glass flask was added 20 g of chloroform containing 5% (v/v) methanol again, the mixture was kept at about 40° C. for 30 minutes and the extract was transferred to the eggplant type flask and mixed with the already-prepared extract. The extract in the eggplant type flask was successively concentrated using a rotary evaporator and a centrifugal concentrating device to give an extract. Amount of phospholipid in the extract was determined using a Phospholipid Test Wako (manufactured by Wako Pure Chemical). The result was that the amount of phospholipid in 100 parts by weight of the dry substance A was 1.6 parts by weight, the amount of phospholipid in 100 parts by weight of the dry substance B was 0.2 part by weight, the amount of phospholipid in 100 parts by weight of the dry substance C was 0.2 part by weight and the amount of phospholipid in 100 parts by weight of the dry substance D was 0.2 part by weight. From the above, it is now apparent that, when phospholipid is added after the miso is heated, phospholipid still remains even after the miso is aged.

### EXAMPLE 2

Soybean (34 kg), 17 kg of rice, 12 kg of salt and 37 kg of water were subjected to preparation, mixing and aging by conventional methods to give 100 kg of miso. The resulting miso was heated at 85° C. (substance temperature) for 5 minutes by the same manner as in Example 1. To 100 g of the heated miso was added 0 g, 0.2 g, 0.4 g, 0.6 g, 0.8 g or 1.0 g of Elmizer AC (enzyme-modified lecithin manufactured by T & K Lecithin) and the mixture was mixed for 10 minutes using a kneader and aged for one week more. Each of the resulting miso was named miso 1 to miso 6. A part of each of miso 1 to 6 was freeze-dried to give dry products 1 to 6. After that, the same method as in Example 1 was carried out except that the dry products 1 to 6 were used instead of the dry product A to C whereupon the amount of phospholipid in 100 parts by weight of each of dry products 1 to 6 was determined. As a result, the amount of phospholipid in 100 parts by weight of each of dry product 1 to 6 was 0.1, 0.4, 0.8, 1.2, 1.6 and 2.0 part(s), respectively.

Miso soup was prepared using a part of each of the above miso 1 to 6 and subjected to an organoleptic test by each 20 males and females in twentieth and thirtieth as panelists. Taste at each adding amount was evaluated according to the following criteria by means of a five-point evaluation method, i.e. the taste when the adding amount of Elmizer AC was 0% (lecithin-free) was 3 points on a maximum of 5 points.

5 points: far better than the lecithin-free miso

4 points: better than the lecithin-free miso

3 points: the same as the lecithin-free miso

2 points: inferior to the lecithin-free miso but it is still able to be eaten as a miso soup 1 point: inferior to the lecithin-free miso and it is no longer able to be said to be a miso soup

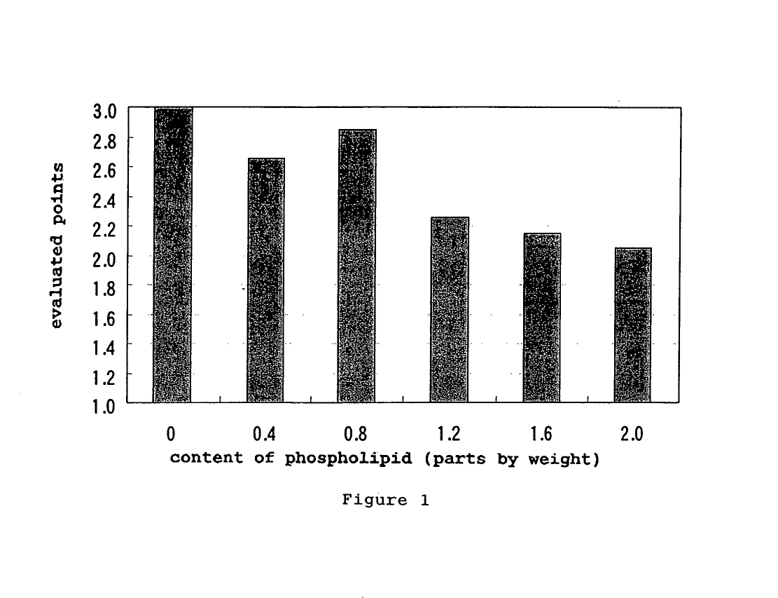

The result by the panelists is shown in FIG. 1. As shown in FIG. 1, all miso soups prepared using the miso products 1 to 6 were the miso soups having the taste which was able to be eaten.

### EXAMPLE 3

An example for producing a miso-containing food is shown below. Firstly, two sheets of sea tangle (Laminaria japonica produced in Rausu) were placed in 1 liter of water, allowed to stand for 1 hour, heated and taken out immediately before boiling. After boiling, 20 g of shavings of dried bonito were placed therein and, after re-boiling, extraction was carried out for 3 minutes. After the shavings of dried bonito were removed, chopped leeks and tofu (soybean curd) were placed therein and the mixture was heated for 5 minutes on high heat. After the heating, 85 g of the miso A manufactured in Example 1 were added thereto together with loosening to give a miso soup. The resulting miso soup was able to be eaten in the same good taste as that prepared using the common miso.

### EXAMPLE 4

An example of a process for producing a freeze-dried miso soup is shown. The miso soup (200 ml) produced in the above-mentioned Example 3 was allowed to cool, frozen at −80° C. and dried by a freeze-drier. The dried product was suspended in 200 ml of hot water to give a product which was able to be eaten as a miso soup having a good taste.

### EXAMPLE 5

An example of a process for producing a lipid metabolism improving agent in a tablet type is shown. The dry product A produced in Example 1 (2 g), 2.6 g of sugar powder, 150 mg of ascorbic acid, 0.1 g of citric acid, 150 mg of sucrose stearate and 15 mg of perfume were mixed and made into tablets according to a conventional method.

In accordance with the present invention, it is now possible to provide a method of potentiating a lipid metabolism improving action of miso and to provide a process for producing a miso having such an improved action.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A method of potentiating a lipid metabolism improving action of miso which comprises subjecting a prepared mixture of materials for miso to aging followed by a heating treatment, and then adding thereto phospholipid.

2. The method of potentiating a lipid metabolism improving action of miso according to claim 1, wherein the heating treatment is conducted for 3 to 40 minutes where the substance temperature is 70° C. to 95° C.

3. The method of potentiating a lipid metabolism improving action of miso according to claim 1, wherein the heating treatment is conducted for 3 to 5 minutes where the substance temperature is 75° C. to 85° C.

4. The method of potentiating a lipid metabolism improving action of miso according to claim 1, wherein further aging is carried out after addition of the phospholipid.

5. The method of potentiating a lipid metabolism improving action of miso according to claim 1, wherein the phospholipid is added so as to make its content based on 100 parts by weight of dried product of the miso 0.4 to 2.0 part(s) by weight.

6. The method of potentiating a lipid metabolism improving action of miso according to claim 1, wherein the phospholipid is an enzyme-modified lecithin.

7. The method of potentiating a lipid metabolism improving action of miso according to claim 1, wherein the lipid metabolism improving action is a cholesterol lowering action.

8. A process for producing miso, comprising subjecting a prepared mixture of materials for miso to aging followed by a heating treatment, and then adding thereto phospholipid.

9. The process for producing miso according to claim 8, wherein the heating treatment is conducted for 3 to 40 minutes where the substance temperature is 70° C. to 95° C.

10. The process for producing miso according to claim 9, wherein the heating treatment is conducted for 3 to 5 minutes where the substance temperature is 75° C. to 85° C.

11. The process for producing miso according to claim 8, wherein further aging is carried out after addition of the phospholipid.

12. The process for producing miso according to claim 8, wherein the phospholipid is added so as to make its content based on 100 parts by weight of dried product of the miso 0.4 to 2.0 part(s) by weight.

13. The process for producing miso according to claim 8, wherein the phospholipid is an enzyme-modified lecithin.

14. The process for producing miso according to claim 8, wherein the lipid metabolism improving action is a cholesterol lowering action.

15. Miso obtainable by the process according to claim 8.

16. A food or drink containing the miso according to claim 15.

17. A method of treating or preventing diseases selected from the group consisting of fatty liver, hypertension, hyperlipemia, arteriosclerosis, obesity, diabetes and myocardial infarction in human or non-human, which comprises ingesting miso according to claim 15.

18. A method of treating or preventing diseases selected from the group consisting of fatty liver, hypertension, hyperlipemia, arteriosclerosis, obesity, diabetes and myocardial infarction in human or non-human, which comprises ingesting the food or drink according to claim 16.

19. A method of improving lipid metabolism in human or non-human, which comprises administrating a pharmaceutical agent comprising miso according to claim 15.
